(19) United States
(12) Patent Application Publication
(10) Pub. No.: US 2005/0216301 A1
(43) Pub. Date: Sep. 29, 2005

(54) Itinerary planning tool, system, and method

(76) Inventor: Kevin Lee Brown, Springfield, VA (US)

Correspondence Address: Kevin Lee Brown, 7917 Currleigh Park Way, Springfield, VA, 22152, US

(21) Appl. No.: 11/080,254

(22) Filed: Mar. 14, 2005

Related U.S. Application Data
(60) Provisional application No. 60/556,777, filed on Mar. 28, 2004.

(51) Int. Cl. G06F 17/60

(52) U.S. Cl. 705/1; 705/6; 705/13

(57) ABSTRACT

An activity-based itinerary planning tool permits a trip planner to incrementally build and itinerary starting at a selected entry point and adding activities in a step-by-step manner, by taking into account commute times for different types of transportation and entry/exit conditions for particular activities/facilities in order to present the user with lists of all activities/facilities that can be reached from the entry point or from already selected activities/facilities.

This application claims the benefit of U.S. Provisional Patent Application Ser. No. 60/556,777, filed Mar. 28, 2004.

### BACKGROUND OF THE INVENTION

1. Field of the Invention

This invention relates to software for planning itineraries, hereinafter referred to an “itinerary planning tool.” The tool permits a user to select activities and incrementally create an itinerary by:
selecting an entry point;
retrieving data concerning all activities accessible from the entry point, and available start times and durations;
calculating whether available start times and durations intersect a time window determined by arrival at the entry point and a departure date, and commuting time between the entry point and the facility where the activity is to take place or begin (based on a selected or automatically chosen mode of transportation), in order to exclude activities generate a list of possible activities;
displaying a the list of possible activities, together with any available related information, such as sponsor information; and
upon selection by the user of an activity, adding the activity to an Itinerary.
In addition, the itinerary planning tool of the invention enables adding to an itinerary by:
retrieving data concerning all activities accessible from a previously selected activity, and available start times and durations;
calculating whether available start times and durations intersect a time window determined by that takes into account a commute time between activities, and using the calculation to exclude activities from a second list of potential activities;
displaying the second list of possible activities;
upon selection of an activity from the second list of possible activities, continuing to retrieve data on available activities and display lists until the Itinerary is completed or system resources are exceeded.

In a preferred embodiment of the invention, the itinerary planning tool is implemented in the form of a website or .html pages stored on a server and downloaded upon request via a web browser to a computer or other computing device. Alternatively, the itinerary planning tool may be provided in the form of a software installed at the user's end. In either case, the itinerary planning tool is arranged to access one or more databases containing information on activities, including locations, times of availability and, optionally, sponsor information or advertisements. The database(s) may be local, i.e., stored on the server that contains the planning device, or may be accessed remotely.

By “activities” is meant any action to perform that has a start time, a duration, and a supplier. This includes not only events, tours, amusements, and the like, but also meals, lodging, car rentals, and other trip items that need to be scheduled, together with incidents of activities such as rental of equipment, waiting in line, parking, and so forth.

Unlike conventional trip planning tools available over the Internet, the trip planning tool of the invention calculates travel or “commute” times between facilities where activities are to take place, based on a selectable or automatically chosen mode of transportation, and excludes facilities that cannot be reached during times that the activity is available, thereby precluding invalid itineraries.

The trip planning tool of the invention is part of a system and method that enables Internet users to prepare activity-based itineraries in a simple and intuitive manner, by selecting from among a variety of activities and modes of transportation while automatically taking into account time and distance.

2. Description of Related Art

Numerous travel planning products are currently available to assist in making reservations for transportation, lodging, meals, and events, and to provide travel directions. These conventional “itinerary planning” products, which include popular websites accessible under the names Expedia, Orbitz, PriceLine and Hotwire, can be used to build crude itineraries that encompass airline flights, vehicle rentals, lodgings, meals, and selected events, but leave it up to the user to ensure that scheduled activities do not overlap and that there is sufficient time to get to the facilities that provide the lodgings, meals, and events. This can be a time-consuming and error-prone process, especially if the user is unfamiliar with the area in which the activities are to take place.

The problem, in essence, is that most currently available itinerary planning products permit the user to select events or facilities without verifying whether it is possible to reach the facilities, and thus have the disadvantage of either permitting the user to make reservations for events that cannot be reached within the time allotted, or to spend time researching and calculating travel times. The most popular of these products, Expedia, Orbitz, PriceLine and Hotwire, all enable the user to make airline reservations, rent a car, rent accommodations, and make advance ticket purchases without regard to whether there are conflicts between scheduled activities.

If the user plans to rent a vehicle, the user can turn to “route planning” products such as Rand McNally TripMaker Deluxe 2004, which provide detailed directions and travel times between selected locations. The information obtained from these products can then be used to look-up lodging, meals, and other activities available at the trip destination. However, it is still up to the user to prevent conflicts between activities based on the route information. The “route planning” software does not automatically narrow down potential activities in order to ensure that there are no conflicts.

As a result, even with the assistance of “route planning” software, building an “itinerary” using conventional travel planning products is, in practice, an unwieldy process that requires multiple information sources and/or repeated visits to different websites. Planning a trip to an unfamiliar location using currently-available trip planning tools can takes hours, and often ends up being no more efficient than simply using a guidebook and telephone.

What is needed is a way to apply the incremental itinerary planning paradigm of a guidebook, in which all activities are available in a single source, with the advantages of automated calculation of commute times between activities, storage of results, and real time verification of facility availability or making of reservations. To date, none of the available travel planning products or tools permits such incrementally building of a detailed, step-by-step itinerary that not only lists activities, but that also takes into account transportation times and therefore precludes invalid itineraries. Even where simple route planning tools are integrated with or hyperlinked to websites that offer lodging and car rental reservations, the user often must:
determine from websites that provide lists of activities what activities are available at what times,
if traveling by a vehicle rented at the destination, turn to route planning software to determine which activities can be reached in available times,
return to the activity listing websites to cross-check arrival time against hours of operation, verify actual availability, and narrow the list of activities,
return to route planning software to select different routes as necessary,
and so forth.

This process, which is already difficult and time-consuming, is greatly complicated if the area is question is a popular destination and only a few time slots are available for each activity, or if other modes of transportation are to be taken into account, such as island-hopping flights, ferries, trains and urban mass transportation, bicycles, and foot travel. Most “route planning” programs assume car travel only, while the travel websites offer only limited alternative modes of transportation and offer information on activities reachable by car only, without considering the possibility of using the alternative modes of transportation to expand the range of possible activities available at a particular destination.

Use of “itinerary” creating software such as Expedia or the like does have the significant advantage of ensuring the availability of facilities, but only if the trip planner already knows where he or she is going, and only needs to match the closest available flight times and dates. On the other hand, use of route planning software such as the Rand McNally TripMaker Deluxe 2004 has the advantage of permitting the user to calculate the quickest, shortest routes, provides directions between waypoints, and provides the ability to choose sites of interest along planned route based on distance from route, but only if the trip planner is traveling by automobile. Both types of trip planning products fail to validate arrival time and stop-over duration against facility hours of operation. Neither takes into account, in a convenient and integrated manner, the possibility of using modes of transportation other than vehicles and adjustment of an itinerary to include side trips by boat or plane rather than just car, much less automatically select a mode of transportation that will enable the facility to be reached in the allotted time.

It should be understood that the term “itinerary” as used herein refers to creation of an individualized itinerary, as opposed to a pre-packaged itinerary in which lodging, meals, theater tickets, event passes, and so forth are sold as a “package” and only limited departures from the predetermined itinerary are possible. Many commercial websites that purport to facilitate “itinerary planning” actually simply present a list of pre-packaged itineraries, with little possibility of departure from a pre-selected schedule of time slots for visiting a limited selection of restaurants, lodgings, and attractions.

Aside from the above-reference commercially-available products, several prior patents disclose what are described as route planning tools or software. These include:
U.S. Pat. No. 5,559,707, which describes a system that lists points of interest within a predetermined radius of a selected destination, but does not calculate travel times, and permit selection of modes of transportation or permit building an itinerary by listing facilities reachable within a selected time from a point of entry or previously selected facility; and
U.S. Pat. Nos. 5,940,803 and 6,119,095, which describe itinerary planners that enable building of an itinerary by selecting places to visit, calculating the commute time to the place, and choosing a time to stay at each location, but that do not preclude the planner from choosing facilities or locations that cannot be arrived at recommended visiting time or within allowable margins, and that have the further disadvantage of failing to provide lists of available activities from which to choose.

With respect to the latter patents, the commercial websites at least have the advantage of highlighting certain activities available in a particular area. The itinerary planners disclosed in U.S. Pat. Nos. 5,940,803 and 6,119,095 force the user to input desired locations and activities before presenting a list of facilities. If the user is unfamiliar with a particular destination region, then the user may not choose the most interesting activities available, preventing the user from taking full advantage of the experiences available at the chosen travel destination. The only current solution is to turn to a secondary source of information, such as a guidebook or website with information on the destination.

Finally, none of the itinerary planning tools discussed above even considers more mundane processes of entering and exiting an activity, such as packing and checking out of a lodging, parking and waiting in line to enter and exit a crowded event or attraction, and so forth. If the activity is rental of an item, consideration must be given to the time it takes to check the rented item out and to return the item, as well as to acquire any external resources necessary to engage in the activity, such as transport for the rented item. For example, a kayak trip without a rental stand near the entry point will require renting a kayak and transporting it, as well as final return back to the rental agency, all of which time, and all of which needs to be considered when checking for conflicts between activities based on “commute” times between the activities for a chosen mode of transportation.

### SUMMARY OF THE INVENTION

It is accordingly a first objective of the invention to provide an itinerary planning tool, and a system and method utilizing such a tool, that only presents activities that can be commuted to, from an entry point or previous activity, in the allotted time during the hours of operation of the activity, thereby automatically precluding the creation of invalid itineraries and the necessity of terminating the itinerary planning process and starting over, and yet that presents the user with a list of all available, non-conflicting activities so that the user can take full advantage of the offerings presented by a chosen destination or region, without having to guess at what is available or refer to a secondary source of information in order to input all desired activities or places to visit at the beginning of planning.

It is a second objective of the invention to provide an itinerary planning tool, system, and method that enables users to plan an itinerary that includes lodging, meals, activities, and modes of transportation, that displays a list of all activities that it is possible to take part in within or at selected times periods, and that ensures that all intended activities will be in accordance with entry and exit conditions, i.e., that sufficient time is available to carry out the activities taking into account transportation times between activities for a selected mode of transportation.

It is a third objective of the invention to provide an itinerary planning tool that takes into account multiple transportation options for reaching available facilities, rather than just automobiles, allowing the user to reach places unattainable by car, travel faster to reach more distant locations, including those separated by water, and take advantage of numerous public systems available in an urban environment.

It is a fourth objective of the invention to validate processes of going from one activity to another, including entering and exiting an activity, and enforce accountability for mundane activities like the time needed to check out of accommodations and returning rental car.

These objectives are accomplished, in accordance with a preferred embodiment of the invention, by providing an activity-based itinerary planning tool in which itineraries are built iteratively from selected entry points, by taking into account commute times for different types of transportation and entry/exit conditions for particular activities/facilities in order to present the user with lists of all activities/facilities that can be reached from the entry point or from already selected activities/facilities.

It will be appreciated by those skilled in the art that the invention may make use of known route planning methods or algorithms that permit the travel time between two points to be calculated. Instead of simply planning a route and displaying travel times, however, the itinerary planning tool of the invention uses the travel times as a basis for selecting facilities at which activities may be carried out. For example, if the selected starting point is the airport, the itinerary planning tool of the invention will provide the user with a list of all activities that can be reached from the airport within a given time, and time slots when the activities are available, excluding those that cannot be reached and taking into account entry/exit conditions as well as travel times, thereby permitting the user to select the activity and/or a facility in which the activity is to take place with minimal likelihood of conflict under normal conditions (excluding weather, unusual traffic, unscheduled closures, or other circumstances that might cause a conflict to occur). The “activity” might be having lunch, checking into a place of lodging, visiting a museum, kayaking, or taking a shuttle to another island. Once the user has selected the activity and time, the itinerary planning tool will present the user with another list of available “activities” and/or “facilities” and so forth, until the itinerary is completed.

Those skilled in the art will appreciate that the itinerary planning tool of the invention is “activity-based” rather than “location-based.” Furthermore, the itinerary planning tool of the invention preferably permits the selection of “subsets”, of an activity, which takes into account the concept of “divisibility” The most general “activity” will have a start time, a duration, a supplier, an action to perform and divisibility. However, not all activities are divisible. For example, a snorkel trip by boat is indivisible. One cannot start the activity late since the boat will have already left, and one cannot end the activity early because the boat is still under way. The itinerary planner of the invention takes into account the fact that the activity must be attended in whole, and declares the activity unattendable if a previous or subsequent activity, including travel times and entry/exit conditions, does not permit the activity to be attended as a whole.

According to the preferred implementation of the invention, activity hours of operation are retrieved from a database and the user refines the selection by providing a “time window” defined by the start time and the amount of time or duration that the user would like to stay at the location. This time window intersects the activities, breaking them up into subsets. The possible activity attendances are limited to subsets contained within the time window and are available for selection, while indivisible activities that are intersected are represented as missed activities and are unavailable for selection. The planner can continues to change the time window until satisfied with amount of time spent on the activity.

It should be understood that the term “activity” as used herein is not limited to a particular type of activity, and that it may encompass checking in, checking out, or spending time at a place of lodging; acquiring, returning, or using a rental item; eating a meal; visiting an attraction such as a museum or monument; taking a tour; attending a show or event; climbing a mountain; or any other item that needs to be, or that is susceptible of being, scheduled in advance in order to ensure that there will be time for the activity. On the other hand, the term “facility” refers to the location where the activity takes place, or in the case of an activity that does not take place at single location, to the entry and exit points for the activity, while the term “commute” refers to travel between facilities, irrespective of mode of transportation. It is one of the advantages of the invention that the itinerary can take into account a variety of modes of transportation, including multiple modes of transportation in a single commute, either automatically selected based on time, distance, and availability, or selectable in whole or in part by the itinerary planner.

### BRIEF DESCRIPTION OF THE DRAWINGS

FIG. 1 is a schematic diagram of an itinerary planning system than includes an itinerary planning tool constructed in accordance with the principles of a preferred embodiment of the invention, including external components needed to carry out operations.

FIG. 2 is a data flow diagram showing the interaction of highest level components used in building an itinerary according to the principles of the invention.

FIG. 3 is a data flow diagram showing interaction of components used in selecting the activities at the first visited location in the itinerary.

FIG. 4 is a data flow diagram showing the process of adding a selected activity to the itinerary.

FIG. 5 is a data flow diagram showing the process of calculating possible activities given an allotted amount of time.

FIG. 6 is a data flow diagram showing the process of calculating possible destinations given a single mode of transportation.

FIG. 7 is a data flow diagram showing the process of calculating possible destinations given the flexibility to choose multiple modes of transportation.

FIGS. 8-10 are “screen shots” showing examples of display screens for allowing a user to input selections of possible activities.

### DETAILED DESCRIPTION OF THE PREFERRED EMBODIMENTS

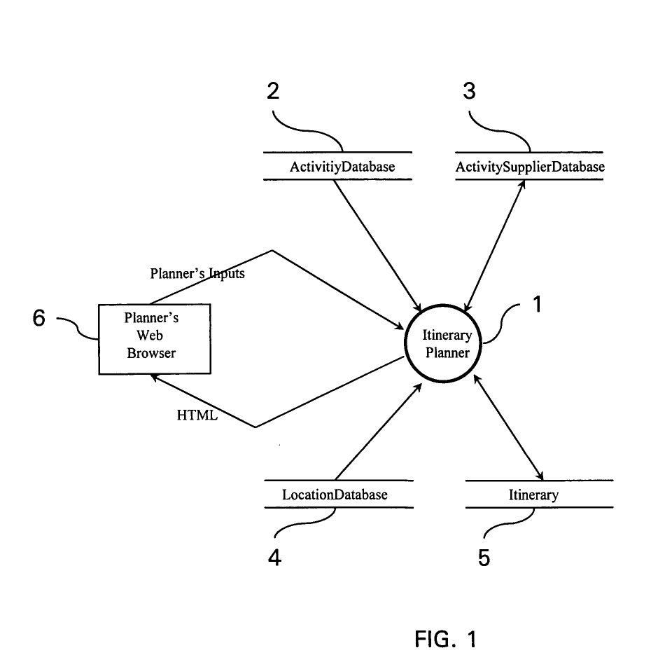

FIG. 1 is a schematic diagram of an itinerary planning tool and system constructed in accordance with a preferred embodiment of the invention. The itinerary planning tool 1 is preferably offered over the Internet and resides in one or more servers to which a “planner” or end user of itinerary planning tool 1 may be connected with the assistance of a web browser 6 that resides on the planner's computer, local area network server, or computing device such as a PDA or cellular telephone. The planning tool is further connected to various databases, which may be locally stored in the same facility as the planning tool, or distributed over a number of locations connected over the Internet or via other communications lines or networks. Those skilled in the art will appreciate that the hardware on which the planning tool of the preferred embodiment may be installed and in which the databases are stored is currently available and forms no part of the present invention, and that those skilled in the art will be able to implement the system in the form of “webpages” written in hypertext mark-up language, or a similar language, that is readable by the planner's browser and through which the user may interact with the itinerary planning tool by inputting and receiving data in a well-known manner.

The databases, whose purpose will be described below, include an ActivityDatabase 2, an ActivitySuppliers Database 3, a Location Database 4, and an ItineraryDatabase 5 for storing itineraries created by planners or users of the itinerary planning tool of the invention. The ActivityDatabase stores descriptions of activities. The ActivitySuppliers Database supplies information about the party that is responsible for executing the activity. The LocationDatabase supplies information about facilities or locations that are associated with the activity. The end result of the itinerary planning shall be referred to herein as the “Itinerary.” It will of course be appreciated that any or all of the databases may be present in a single memory storage location, or distributed over multiple locations, and that the databases may be further divided into sub-databases or include additional databases.

The planner provides inputs to the itinerary planning software, and/or to the system that includes the itinerary planning tool or software, through interaction with web browser 6. In addition, the itinerary planning tool will requires data from the current Itinerary. In the case of a web-based itinerary planning tool, the tool sends HTML web pages back to the planner for additional input requests and display of incremental progress in building the Itinerary. The Itinerary is the final product produced by the tool.

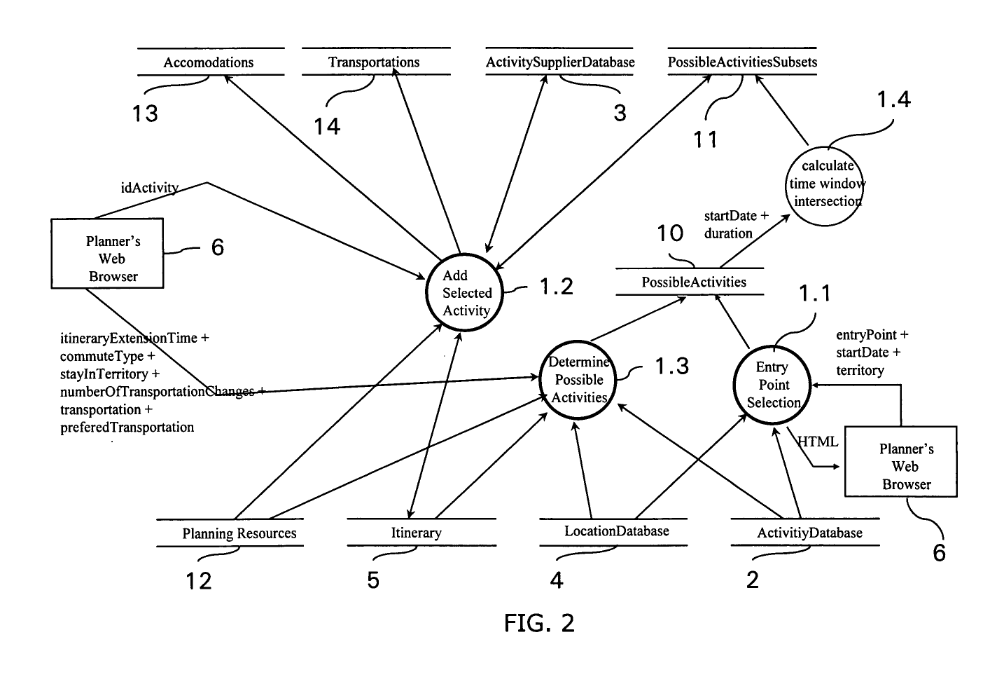

FIG. 2 shows the interaction of highest level components used in building the Itinerary. The planner starts the Itinerary by selecting from possible entry points into a territory (block 1.1). The entry points may include, but are not limited to, airports, ports, train, bus stations, other transportation hubs or border crossings, depending the particular characteristics of the territory and its relationship to the territory of origin of the planner, or the location of another activity (for example, the planner might wish to begin planning an itinerary starting from the end of a convention or business meeting). Once the entry location is established, activities are retrieved from the ActivityDatabase 2 based on the selected entry location. The itinerary planning tool then determines (block 1.3) all activities 10 that it is possible to commute to within a given allotted time based on an itineraryExtensionTime input. Finally, the planner inputs the time to start and duration to spend on the activity and subsets 11 of all the possible activities 10 are calculated (block 1.4), after which the planner adds an activity (block 1.2) from the calculated subset 11 of all possible activities and adds it to Itinerary 5. The process is repeated until the is finished adding new activities or has exceeded PlanningResources limits 12.

It will be appreciated that the lists of possible activities can be modified according to pre-selected criteria in addition to availability. By way of example only, the planner may pre-select types of accommodations, meals, transportation options, and/or other activities based on cost, age, general preferences, and so forth, all of which can be taken into account in generating the possible activities 10 or subsets 11 thereof. Furthermore, once an activity is selected, the itinerary planner may contact, or enable the user to contact, the corresponding facility, such as an accommodation stored in an accommodation “inventory” or list 13, for reservations or tickets, as well as arranging for the commute between activities by a particular mode of transportation stored in an another “inventory” 14.

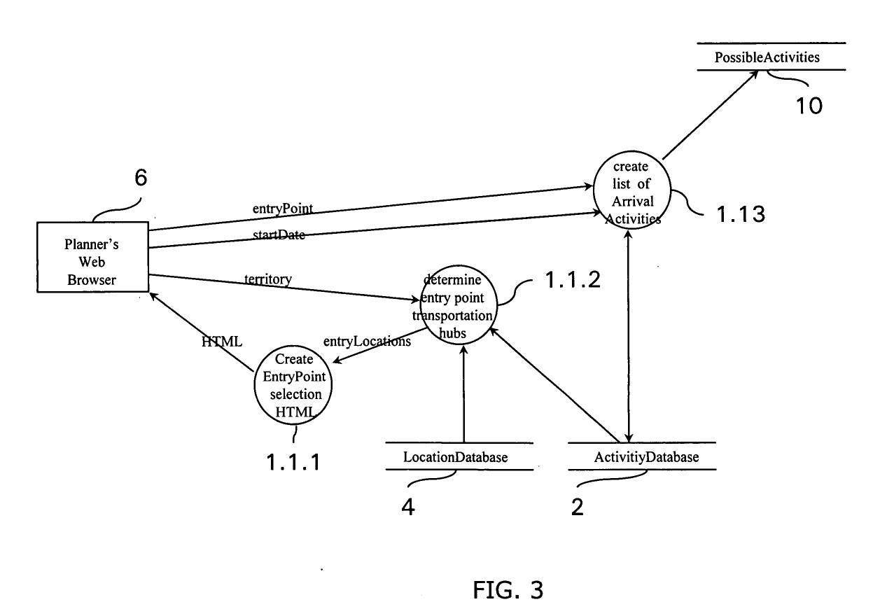

FIG. 3 illustrated the manner in which the Entry Point Selection block 1.1 of FIG. 2 uses the territory input by the planner to retrieve from the ActivityDatabase 2 transportation activities that allow entering the territory (block 1.1.2). The locations of the activities are presented to the planner as a limited set of locations that he may enter the territory. With the selected entryPoint and startDate provided by the planner through an entry point selection screen displayed by the planning tool (block 1.1.1), the itinerary planning tool creates a list of available activities at the entryPoint (block 1.1.3) and deems them to be possible activities to start the Itinerary.

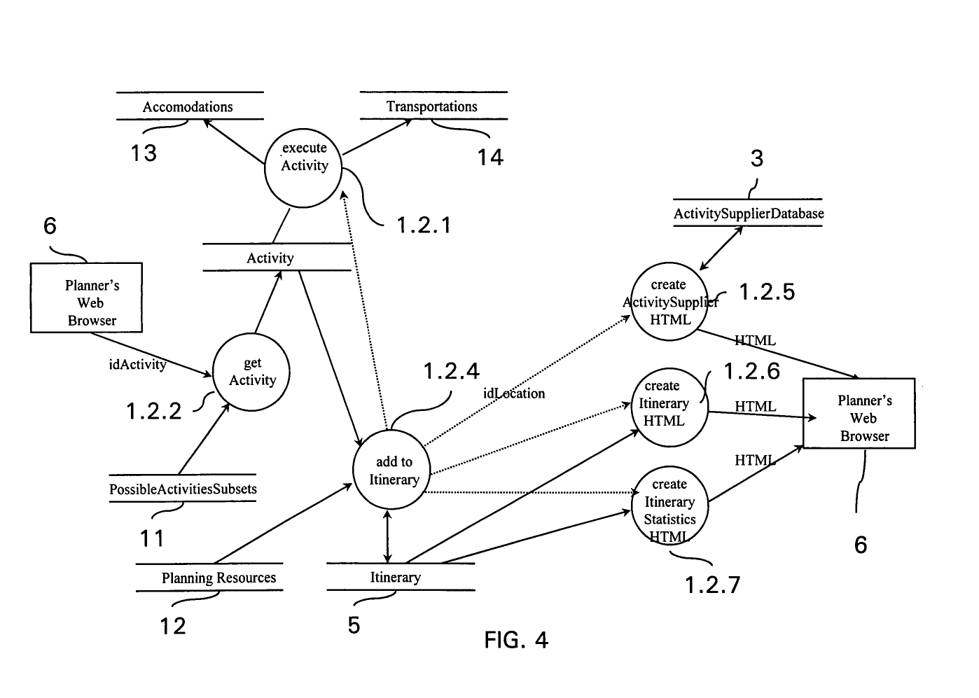

FIG. 4 shows how the preferred planning tool adds an activity selected by the planner to the Itinerary. Upon selection of the activity from the set 11 of all possible activities by, for example, inputting an identifier for the activity, “clicking” on the activity, or the like, the preferred itinerary planning tool retrieve associated data (step 1.2.2) and executes the activity as if the planner were on a trip to determine any side effects and update inventories or running variables associated with Inventory entries or calculations.

“Side effects” are any effects of an activity that affect the availability of the planner to take part in another activity. Possible side effects include, but are not limited to, increases in expenditures, rental items being added to inventory, or a change in location if the activity happens to be a commute. Executing the activity represents a simulation of the planner at the activity. For example, for the activity of scuba diving, execution of the activity may represent a dive signature. If multiple dives occur during the trip, the planner could be prevented from reserving an airline flight before acceptable levels of nitrogen have left his or her blood stream.

The above-mentioned “inventories” are simply lists of items associated with activities in the Itinerary, and that must be updated as the Itinerary is developed. For example, if the activity is checking into an accommodation, the accommodation might be added to an accommodation inventory 13, so as to keep track of accommodation expenses, or alternatively to force a return to the accommodation before check-out. If the activity is renting a car, then the is added to the inventory or stored list of possible transportation 14 for later commutes.

Both side effects and inventories may have an additional effect on planning resources, which are items such as costs that affect the activities that can be carried out. As shown in FIG. 4, whenever an activity is added, Planning Resources 12 are checked against current limits. Only if Planning Resources have not been exceeded is the activity appended to the Itinerary (step 1.2.4). Alternatively, a planner may choose not to keep track of planning resources, or the itinerary planning tool may simply keep a running total of expenses and not provide any limit.

Since the Itinerary has been changed internally in the itinerary planning tool, it is now must be synchronized with the last Itinerary displayed to the planner and the “location” of the planner updated (block 1.2.3) for commute calculating purposes. Blocks 1.2.5, 1.2.6, and 1.2.6 respectively depict display by the itinerary planning tool of information concerning the responsible party or sponsor offering the activity, the most up to date version of the Itinerary, and vital statistics about the Itinerary.

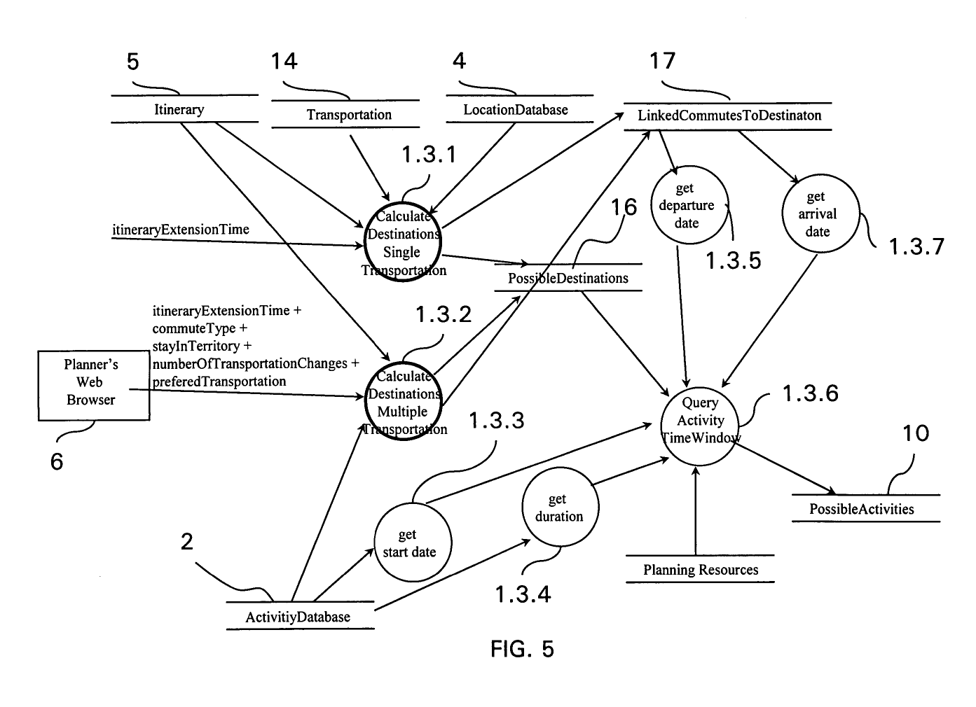

FIG. 5 shows a preferred process for determining possible activities based on automatic selection of transportation modes. In the example of FIG. 5, the itinerary planning tool determines possible destinations 16 based either on a single mode of transportation (block 1.3.1), or automatically selected multiple transportation modes (block 1.3.2), and determines what activities are possible at each destination by retrieving activities from the ActivityDatabase 2 based on their location and whether an activity=s start and end date, depicted as being stored in LinkedCommutesToDestination 17, intersects or falls in the time window of the arrival and departure date of the commute to the destination (blocks 1.3.3 to 1.3.7). All activities that pass the query are declared possible activities 10.

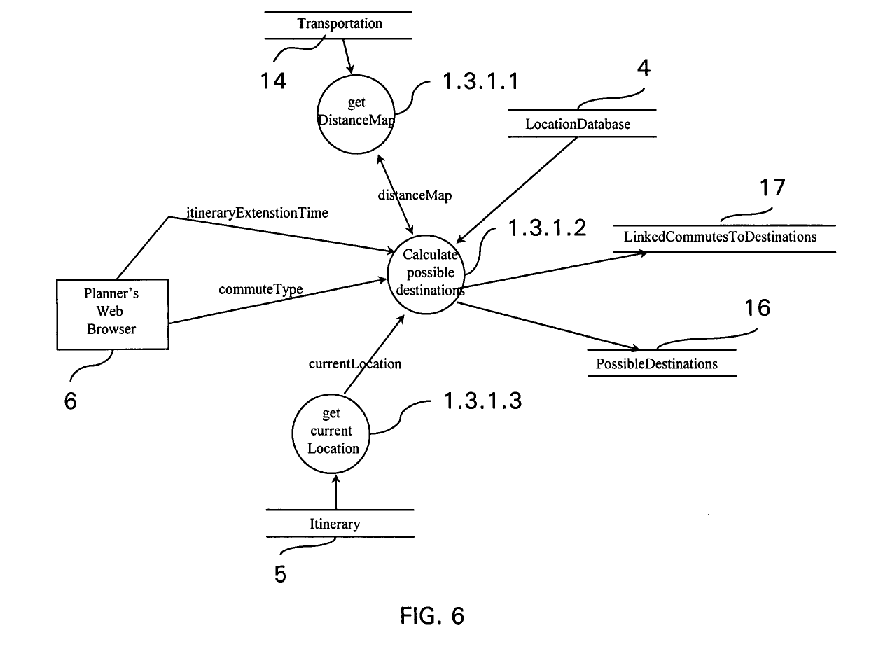

FIG. 6 shows an alternative way of determining possible destinations when the planner has opted to chose a single mode transportation for the commute (see block 1.3.1 of FIG. 5). A distance map is provided for each unique form of transportation (block 1.3.1.1). For example, a car would necessitate a distance map based on street layouts, while transportation by foot would necessitate provision of walking distances based on sidewalk and walking paths. A unique commute time is then calculated (block 1.3.1.2) for the distance between the current location of the Itinerary (retrieved in block 1.3.1.3 Bsee block 1.2.3 of FIG. 4) and all locations in the territory. If the calculated commute time is less than the itinerary extension time, it is deemed to be reachable in the allotted time and added to possible destinations. The associated commute activity is added the LinkedCommutesToDestinations.

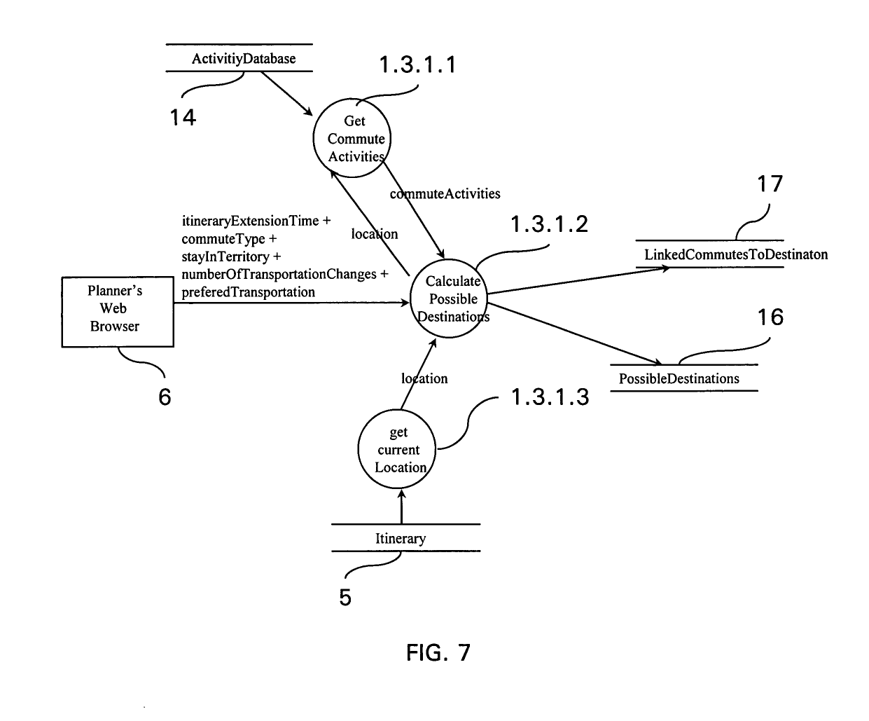

FIG. 7 shows an alternative way of determining possible destinations when the planner has opted to allow the itinerary planning tool to calculate multiple transportation changes in the same continuous commute. Given a location, the ActivityDatabase 2 is queried for activities that are commuting related (block 1.3.2.1). Examples include, but are not limited too, hired car, taxi, or limo service, scheduled bus service, scheduled airplane service, and scheduled train service. The duration of the commute activity is then added to a running total in order to determine possible destinations 16 (block 1.3.2.2). The destination of the commute is used once again used to find commuting activities at the location retrieved in block 1.3.2.3, and the process is repeated until no commuting activities are found at the new destination. If the total cumulative commute time is less than the itinerary extension time, it is deemed to be reachable in the allotted time and added to the list of possible destinations 16, and the associated commute activities are added to the LinkedCommutesToDestinations 17.

Those skilled in the art will appreciate that the multiple transportation mode option provides the flexibility to change and pick different modes of transportation in a single commute. This allows activities that were impossible to reach with a single mode of transportation. Previous “route planning” tools assumed the car as a total transportation solution. The itinerary planning tool of the invention allows for changing from a rental car to a plane, train, bus, or the like to allow visiting multiple territories in the same itinerary.

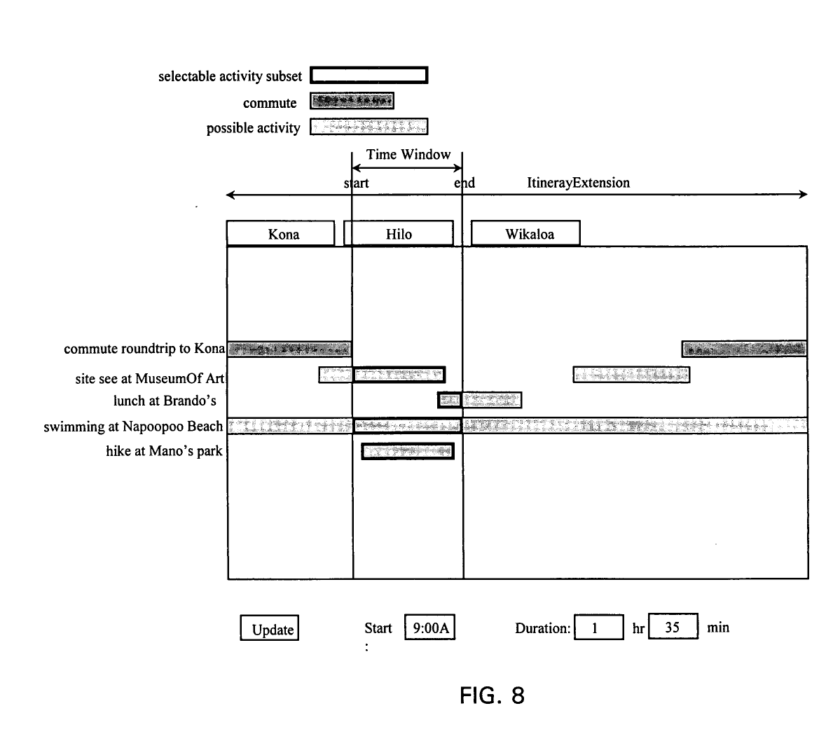

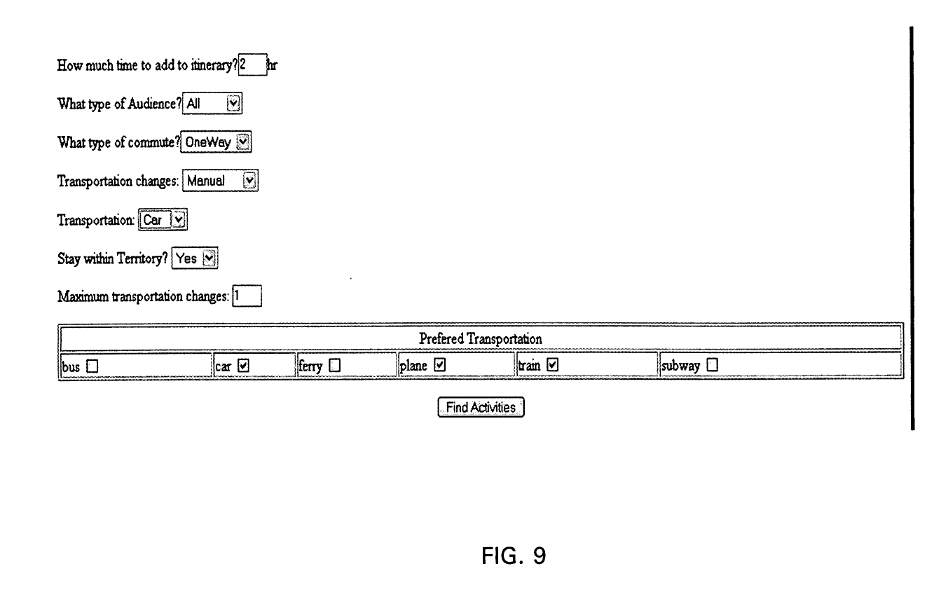

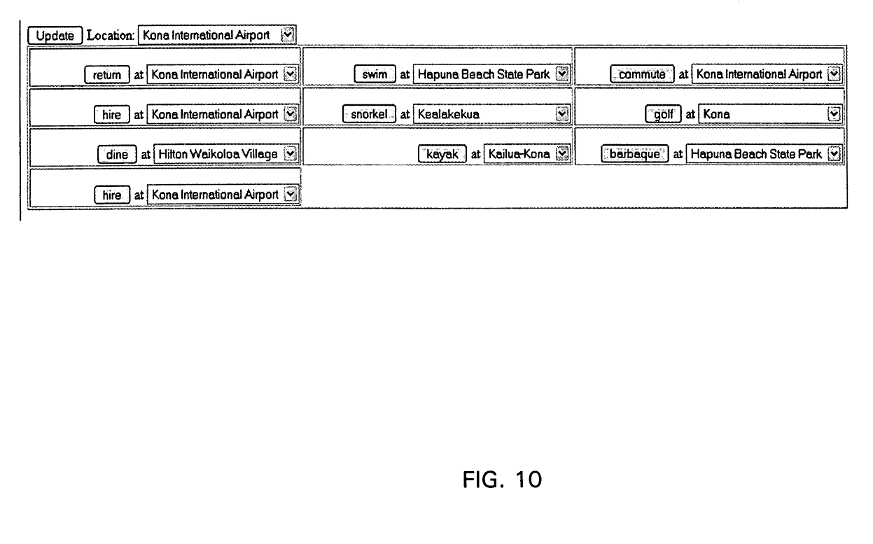

FIG. 8 is a schematic screen shot of a user friendly interface for allowing the planner to select a single subset of an activity from potentially dozens. The Planner provides input of the start time and the duration he wants to spend on the activity and then draws a time window. The provided time window is displayed by two lines intersecting all possible activity time lines at a given location. The possible activities have now been narrowed down to selectable absolute activities. The preferred itinerary planning tool only responds to selections that are located in the time window. The selectable activities are represented by the outlined subsets of the activities. FIG. 9 depicts the input screen for adding an activity, including blocks for selecting transportation modes, while FIG. 10 depicts an alternative example of an input screen for inputting selected activities.

According to a preferred embodiment of the invention, the user or planner selects the amount of time to append to the itinerary, properties of the activity, and process for selecting transportation. If the manual selection option is chosen, the planner picks a single mode of transportation from an inventory he has previously acquired. If he has rented an automobile, the planner may switch from default foot transportation to car. If computer-assisted selection is chosen, the planner selects whether to venture out of current territory, the number of transportation changes, and preferred types of transportation. The itinerary planning tool will then find transportation hubs and change to new transportation types as necessary for the commute.

Once the itinerary is chosen, the itinerary planning tool will calculate how far the planner can commute in the allotted itinerary extension. From the set of reachable locations, all possible activities are retrieved from database that occur at each location. Previous systems required knowledge of activity types in the foreign territory. My system sorts activities by type and presents to Planner for selection as FIG. 10 shows. The Planner selects the activity's location since same activity may happen at several locations.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

1. An itinerary planning tool comprising:
a computing system,
means to retrieve plurality of limited access operation information,
means for enabling a user to input a time window whereby limiting limited access operation engagement,
means for causing said computing system to calculate commute times, based on limited access operation information, between a departure location and destination of limited access operation,
means for causing said computing system to create an limited access operation set that can be engaged in during said time window, based on said limited access operation information and taking into account said commute times,

2. The itinerary planning tool according to claim 1, wherein said limited access operations, include activities.

3. The itinerary planning tool according to claim 1, wherein said limited access operations, include points of interest.

4. The itinerary planning tool according to claim 2, wherein said activities, include activities related to accommodations, meals, and entertainment.

5. The itinerary planning tool according to claim 2, wherein said activities, include activities related to scheduled transportation.

6. The itinerary planning tool according to claim 2, wherein said activities, include activities related to service calls.

7. The itinerary planning tool according to claim 3, wherein said points of interest, include establishments providing accommodations, establishments providing meals, and establishments providing entertainment.

8. The itinerary planning tool according to claim 3, wherein said points of interest, include establishments of scheduled transportation.

9. The itinerary planning tool according to claim 3, wherein said points of interest, include establishments requiring service calls.

10. The itinerary planning tool according to claim 1, wherein said limited access operation information, to include periods of accessibility and geolocation.

11. The itinerary planning tool according to claim 1, wherein said computing system, to be a web server accessible via Internet.

12. The itinerary planning tool according to claim 1, wherein said computing system, to be a vehicle navigation system.

13. The itinerary planning tool according to claim 1, wherein said means to calculate commute times, takes into account changes in multiple modes of transportation to arrive at destination.

14. The itinerary planning tool according to claim 1, further comprising means for information subset selection.

15. The itinerary planning tool according to claim 14, wherein said information subset selection includes means for displaying a graphic representation of said time window superimposed on a displayed said periods of accessibility.

16. The itinerary planning tool according to claim 1, further comprising means for limited access operation engagement simulation.

17. The itinerary planning tool according to claim 16, wherein said limited access operation engagement simulation, takes into account accumulation and reduction of resources.

18. The itinerary planning tool according to claim 16, wherein said limited access operation engagement simulation, takes into account side effects upon other said limited access operations.

19. The itinerary planning tool according to claim 1, further comprising means for retrieving sponser information of said limited access operations.

20. The itinerary planning tool according to claim 19, wherein said sponser information, to include contact information and reservation information.

21. An itinerary planning tool comprising:
a computing system,
means to retrieve plurality of limited access operation information,
means to retrieve plurality of location information,
means for enabling a user to input a time window whereby limiting limited access operation engagement,
means for causing said computing system to calculate commute times, based on said location information, between a departure location and destination location,
means for causing said computing system to assemble a destinations list based on departure location, said commute times and said time window.
means for causing said computing system to assemble an limited access operation list based on said destinations list, said limited access operation information, and said time window.

22. The itinerary planning tool according to claim 21, wherein said limited access operations, include activities.

23. The itinerary planning tool according to claim 22, wherein said activities, include activities related to accommodations, meals, and entertainment.

24. The itinerary planning tool according to claim 22, wherein said activities, include activities related to scheduled transportation.

25. The itinerary planning tool according to claim 22, wherein said activities, include activities related to service calls.

26. The itinerary planning tool according to claim 21, wherein said limited access operations, include points of interest.

27. The itinerary planning tool according to claim 26, wherein said points of interest, include establishments providing accommodations, establishments providing meals, and establishments providing entertainment.

28. The itinerary planning tool according to claim 26, wherein said points of interest, include establishments of scheduled transportation.

29. The itinerary planning tool according to claim 26, wherein said points of interest, include establishments requiring service calls.

30. The itinerary planning tool according to claim 21, wherein said limited access operation information, to include periods of accessibility and location identity.

31. The itinerary planning tool according to claim 21, wherein said location information, to include identity and geoposition.

32. The itinerary planning tool according to claim 21, wherein said computing system, to be a web server system accessible via Internet.

33. The itinerary planning tool according to claim 21, wherein said computing system, to be a vehicle navigation system.

34. The itinerary planning tool according to claim 21, wherein the step of calculating commute times, takes into account changes in multiple modes of transportation to arrive at destination.

35. The itinerary planning tool according to claim 21, further comprising means for information subset selection.

36. The itinerary planning tool according to claim 35, wherein, said information subset selection includes means for displaying a graphic representation of said time window superimposed on a displayed said periods of accessibility.

37. The itinerary planning tool according to claim 21, further comprising means for said limited access operation engagement simulation.

38. The itinerary planning tool according to claim 37, wherein said limited access operation engagement simulation, takes into account accumulation and reduction of resources.

39. The itinerary planning tool according to claim 37, wherein said limited access operation engagement simulation, takes into account side effects upon other activities.

40. The itinerary planning tool according to claim 21, further comprising means for retrieving sponser information of said limited access operations.

41. The itinerary planning tool according to claim 40, wherein said sponser information, to include contact information and reservation information.

42. A software storage device readable by a machine, tangibly embodying a program of instructions executed by the machine to perform method steps for itinerary planning, said method steps comprising steps of:
receiving a plurality of limited access operation information including periods of accessibility and location;
receiving time window input;
receiving departure location;
calculating commute times, based on limited access operation information, between said departure location and destination of activity;
assembling an limited access operation set that can be engaged in during said time window, based on said activity information and taking into account said commute times;

43. The itinerary planning method in claim 42, wherein said limited access operations, include activities.

44. The itinerary planning method in claim 42, wherein said limited access operations, include points of interest.

45. The itinerary planning method in claim 42, further the step of calculating commute times, taking into account changes in multiple modes of transportation to arrive at destination.

46. The itinerary planning method in claim 42, further comprising the step of selecting a subset of information.

47. The itinerary planning method according to claim 42, further the step of selecting a subset of information includes displaying a graphic representation of said time window superimposed on a displayed said periods of accessibility.

48. A software storage device readable by a machine, tangibly embodying a program of instructions executed by the machine to perform method steps for itinerary planning, said method steps comprising steps of:
receiving plurality of limited access operation information including periods of accessibility and location identity;
receiving plurality of location information including identity and geoposition;
receiving time window input;
receiving departure location;
calculating commute times, based on activity information, between said departure location and destination of activity;
assembling a destination list based on said departure location, said commute times and said time window;
assembling a limited access operation set based on operations' location identity matching identities in said destinations list and operations' said period of accessibility relationship to said time window.

49. The itinerary planning method in claim 48, wherein said limited access operations, include activities.

50. The itinerary planning method in claim 48, wherein said limited access operations, include points of interest.

51. The itinerary planning method in claim 48, further the step of assembling a destination list, taking into account changes in multiple modes of transportation to arrive at destination.

52. The itinerary planning method in claim 48, further comprising the step of selecting a subset of information.

53. The itinerary planning method according to claim 48, further the step of selecting a subset of information includes displaying a graphic representation of said time window superimposed on a displayed said periods of accessibility.
